(19) United States
(12) Patent Application Publication
(10) Pub. No.: US 2026/0158860 A1
(43) Pub. Date: Jun. 11, 2026

(54) THERMAL MANAGEMENT SYSTEM AND A METHOD OF CONTROLLING THE SAME

(71) Applicants: HYUNDAI MOTOR COMPANY, Seoul (KR); KIA CORPORATION, Seoul (KR)

(72) Inventors: Jae Woong Kim, Hwaseong-si (KR); Dae Ki Hong, Hwaseong-si (KR); Ki Hoon Kim, Hwaseong-si (KR); Jae Kwon Lee, Hwaseong-si (KR); Se Kyu Oh, Hwaseong-si (KR)

(73) Assignees: HYUNDAI MOTOR COMPANY, Seoul (KR); KIA CORPORATION, Seoul (KR)

(21) Appl. No.: 19/225,666

(22) Filed: Jun. 2, 2025

(30) Foreign Application Priority Data
Dec. 9, 2024 (KR) 10-2024-0181996

(51) Int. Cl. B60H 1/00

(52) U.S. Cl. CPC B60H 1/00885; B60H 1/00807

(57) ABSTRACT

A thermal management system includes a refrigerant line circulating a refrigerant, wherein the refrigerant passes through a compressor, a condenser, an expansion valve, and a heat exchanger. The thermal management system further includes a controller configured to determine a flow rate of the refrigerant discharged from the compressor based on a target temperature in the heat exchanger and to control an opening amount of the expansion valve based on the determined flow rate of the refrigerant discharged from the compressor.

### CROSS-REFERENCE TO THE RELATED APPLICATION

This application claims priority to Korean Patent Application No. 10-2024-0181996, filed on Dec. 9, 2024 in the Korean Intellectual Property Office, the disclosure of which is incorporated herein by reference in its entirety.

### BACKGROUND OF THE PRESENT DISCLOSURE

### Field of the Present Disclosure

The present disclosure relates to a thermal management system and a method of controlling the same to control the opening amount of an expansion valve based on the flow rate of refrigerant discharged from a compressor.

### Description of the Related Art

Recently, in the vehicle industry, a thermal management system has become an essential element for achieving various goals such as improving fuel efficiency, protecting batteries and engines, and providing a comfortable interior environment for occupants. In particular, as the market for electrified vehicles such as electric vehicles and hybrid vehicles expands, the importance of technology for maximizing energy efficiency and providing optimal thermal management in vehicles is increasing.

One of the core factors of such a thermal management system is the refrigerant cycle, and efficient control of an expansion valve and a compressor in the refrigerant cycle is an important element that determines system performance. In the refrigerant cycle, the compressor compresses the refrigerant to a high-temperature and high-pressure state, and the expansion valve controls the flow rate of the refrigerant to convert the high-temperature and high-pressure state to a low-temperature and low-pressure state. The compressor and the expansion valve form a high pressure side and a low pressure side of the system, respectively.

Control of these two devices directly affects the cooling performance and the heating performance of the system, and in particular, control of the expansion valve plays an important role in optimizing the stability and performance of the entire system.

The matters described as background technology above are only intended to enhance understanding of the background of the present disclosure and should not be taken as an acknowledgment that they correspond to prior art already known to those having ordinary skill in the art.

### SUMMARY

Therefore, the present disclosure has been made in view of the above problems, and it is an object of the present disclosure to provide a thermal management system and a method of controlling the same capable of optimally controlling the opening amount of an expansion valve such that refrigerant discharged from a compressor can pass through the expansion value without a change in flow rate thereof.

The objects of the present disclosure are not limited to the objects mentioned above, and other objects not mentioned should be clearly understood by those having ordinary skill in the art from the description below.

In accordance with an aspect of the present disclosure, the above and other objects can be accomplished by the provision of a thermal management system including a refrigerant line circulating a refrigerant, wherein the refrigerant passes through a compressor, a condenser, an expansion valve, and a heat exchanger, and a controller configured to determine a flow rate of the refrigerant discharged from the compressor based on a target temperature in the heat exchanger and control an opening amount of the expansion valve based on the flow rate of the refrigerant.

In accordance with another aspect of the present disclosure, there is provided a method of controlling a thermal management system including a refrigerant line through which refrigerant circulates passing through a compressor, a condenser, an expansion valve, and a heat exchanger, the method including determining a flow rate of the refrigerant discharged from the compressor based on a target temperature in the heat exchanger, and controlling an opening amount of the expansion valve based on the determined flow rate of the refrigerant.

### BRIEF DESCRIPTION OF THE DRAWINGS

The above and other objects, features and other advantages of the present disclosure are more clearly understood from the following detailed description taken in conjunction with the accompanying drawings.

FIGS. 1-3 are diagrams illustrating examples of implementing a thermal management circuit of a thermal management system applicable to embodiments of the present disclosure.

FIG. 4 is a diagram illustrating a controller according to an embodiment of the present disclosure.

FIG. 5 is a diagram illustrating a method of controlling the opening amount of an expansion valve according to an embodiment of the present disclosure.

FIG. 6 is a diagram illustrating a method of controlling a thermal management system according to an embodiment of the present disclosure.

### DETAILED DESCRIPTION

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure can be modified in various manners and have various forms, specific embodiments are illustrated in the drawings and described in detail in the specification or application. However, this is not intended to limit the embodiments according to the concept of the present disclosure to a specific disclosed form, and should be understood to include all changes, equivalents, and substitutes included in the spirit and technical scope of the present disclosure.

All terms including technical or scientific terms have the same meanings as generally understood by those having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification are described in detail with reference to the attached drawings. However, identical or similar components are assigned the same reference numeral, and redundant descriptions thereof will be omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit” or “part” used to signify components are used herein to aid in understanding of the components and thus they should not be considered as having specific meanings or roles. The term “unit” or “module” or “part” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof. When a component, unit, part, controller, device, element, apparatus, or the like of the present disclosure is described as having a purpose or performing an operation, function, or t like, the component, unit, part, controller, device, element, apparatus, or the like should be considered herein as being “configured to” meet that purpose or to perform that operation or function. Each component, unit, part, controller, device, element, apparatus, and the like may separately embody or be included with a processor and a memory, such as a non-transitory computer readable media, as part of the apparatus.

In the following description of the embodiments disclosed in the present specification, a detailed description of known functions and configurations incorporated herein has been omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it is further understood that the terms “comprise” or “include” specifies the presence of a stated feature, figure, step, operation, component, part or combination thereof, but does not preclude the presence or addition of one or more other features, figures, steps, operations, components, or combinations thereof.

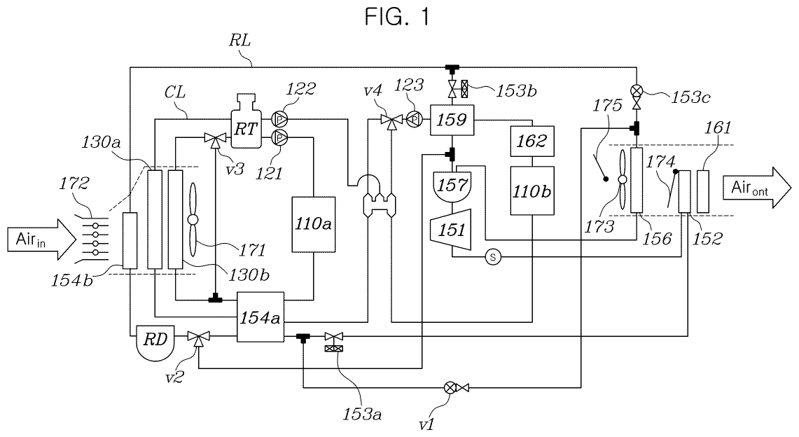

Prior to describing a method of controlling a thermal management system according to an embodiment of the present disclosure, examples of implementing a thermal management circuit constituting the thermal management system are described below with reference to FIGS. 1-3.

FIGS. 1-3 are diagrams illustrating examples of implementing the thermal management circuit of the thermal management system applicable to embodiments of the present disclosure.

Referring to FIG. 1, the thermal management system includes a refrigerant line RL, and may perform cooling/heating in a vehicle and thermal management of vehicle components through the refrigerant line RL.

More specifically, the thermal management system may be provided with a coolant line CL for exchanging heat with vehicle components 110a and 110b in addition to the refrigerant line RL. The refrigerant circulating in the refrigerant line RL and the coolant circulating in the coolant line CL can exchange heat with each other.

More specifically, the vehicle components 110a and 110b that are subject to thermal management may be connected to the coolant line CL, and the temperature of the vehicle components 110a and 110b may be managed to an appropriate range or a target temperature through heat exchange between the vehicle components 110a and 110b and the coolant line CL.

The vehicle components 110a and 110b may include a drive system 110a such as a motor and an inverter, and a battery 110b. However, in embodiments of the present disclosure, the vehicle components 110a and 110b are not necessarily limited to the above examples, and may include various components that require heat dissipation. For example, vehicle components that are subject to thermal management and connected to the coolant line CL may include various types of controllers (not shown), such as an automated driving controller, a motor controller, a vehicle controller, and a controller involved in performing integrated thermal management according to an embodiment of the present disclosure.

Although FIG. 1 illustrates the coolant lines CL for thermal management of the drive system 110a and thermal management of the battery 110b, such coolant lines CL may be replaced with coolant lines for thermal management of other vehicle components 110a and 110b such as a controller, or may coexist with coolant lines for thermal management of other components in implementation. In addition, various implementation examples may include various cases such as a case in which only a single coolant line is provided for thermal management of a single component, and a case in which a plurality of components is connected in series to a single coolant line.

Coolant pumps 121, 122, and 123 may be provided for circulation of the coolant in the coolant lines CL1 and CL2, and the coolant pumps 121, 122, and 123 may consume power to flow the coolant to the vehicle components 110a and 110b. Such coolant pumps 121, 122, and 123 may be implemented as an electric water pump (EWP) that circulates coolant by driving a motor with electrical energy, for example.

The coolant introduced to the vehicle components 110a and 110b through the coolant pumps 121, 122, and 123 may absorb heat generated in the vehicle components 110a and 110b through heat exchange while passing through the vehicle components 110a and 110b, thereby cooling the vehicle components 110a and 110b.

The coolant that has absorbed heat while passing through the vehicle components 110a and 110b may flow to radiators 130a and 130b, and in the process of passing through the radiators 130a and 130b, releases the heat absorbed from the vehicle components 110a and 110b to the surroundings and then flows back to the vehicle components 110a and 110b. In this case, the radiators 130a and 130b may be divided into a low-temperature radiator 130a and a high-temperature radiator 130b.

A compressor 151, a condenser 152, expansion valves 153a, 153b, and 153c, and heat exchangers are provided on the refrigerant line RL, and the refrigerant circulates through the refrigerant line RL passing through these components.

More specifically, the refrigerant line RL may be equipped with heat exchangers such as a water-cooled condenser 154a, an air-cooled condenser 154b, a chiller 159, and an evaporator 156, and heat exchange between the refrigerant and the surrounding environment occurs in such heat exchangers.

The compressor 151 may consume power to discharge the refrigerant in a high-temperature and high-pressure state, and the high-temperature and high-pressure refrigerant that has passed through the compressor 151 expands in the expansion valves 153a, 154b, and 153c, is converted into a low-temperature and low-pressure state, and lowers the surrounding temperature by exchanging heat with the surrounding environment through the heat exchangers in the low-temperature and low-pressure state. In an embodiment, the expansion valves 153a and 153b may be implemented electronically, and the expansion valve 153c may be implemented thermally.

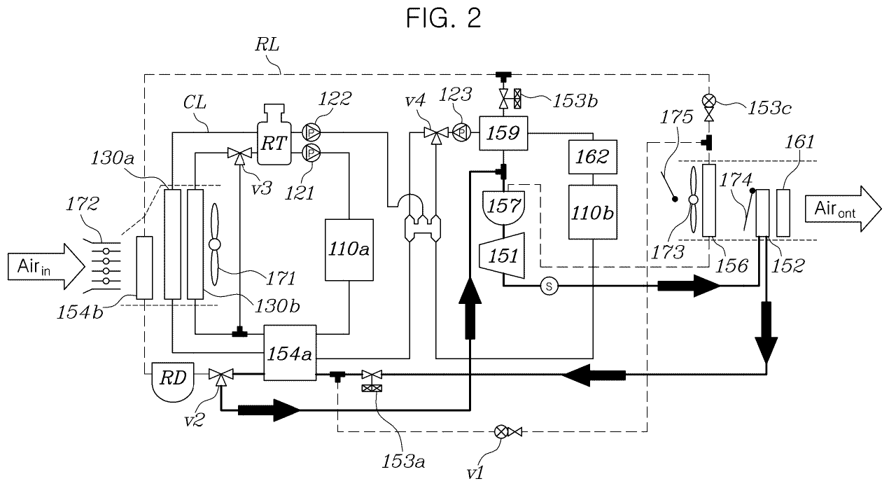

For example, when heat is exchanged through the water-cooled condenser 154a, heat of the coolant lines CL1 and CL2 connected to the vehicle components 110a and 110b may be absorbed through the heat pump function of the refrigerant line RL. More specifically, referring to FIG. 2, the high-temperature and high-pressure refrigerant that has passed through the compressor 151 is converted into a low-temperature and low-pressure state while passing through the condenser 152 and the expansion valve 153a, and the low-temperature and low-pressure refrigerant exchanges heat with the coolant lines CL1 and CL2 in the water-cooled condenser 154a. After heat exchange, the refrigerant passes through an accumulator 157 and flows back into the compressor 151, and through repetition of this process, heat management of the vehicle components 110a and 110b through the heat pump function can be performed.

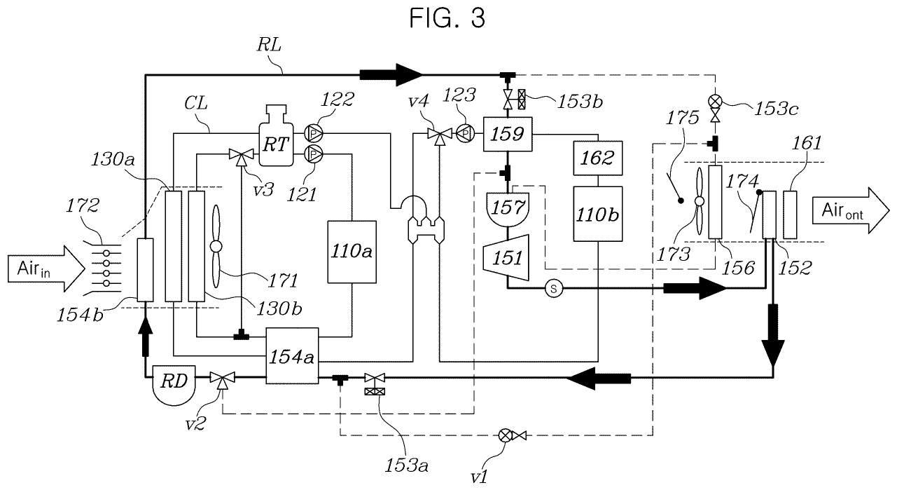

In addition, when heat is exchanged through the chiller 159, the battery 110b connected to the chiller 159 can be cooled. More specifically, referring to FIG. 3, the high-temperature and high-pressure refrigerant that has passed through the compressor 151 is converted into a low-temperature and low-pressure state while passing through the expansion valve 153b, and the low-temperature and low-pressure refrigerant exchanges heat with the coolant line CL2 in the chiller 159. After heat exchange, the refrigerant passes through the accumulator 157 and flows back into the compressor 151, and through repetition of this process, cooling of the battery 110b can be performed as a result.

Further, the thermal management system may also be equipped with a cooling fan 171 and an air flap 172 for controlling inflow of outside air, a receiver dryer RD for removing moisture from the refrigerant passing through the water-cooled condenser 154a, a reservoir tank RT having a coolant storage space, valves v1, v2, v3, and v4 for controlling the flow of refrigerant or coolant, an indoor heater 162 for cooling/heating, an evaporator 156, a blower 173, a temp door 174, an intake door 175, an indoor heater 162 for increasing the temperature of the battery, and the like. In addition, a high-pressure side sensor S capable of detecting at least one of temperature and pressure may be provided on the outlet side of the compressor 151.

According to the thermal management circuit of the thermal management system described above, various types of thermal management can be performed, and in particular, when the thermal management system is applied to a vehicle, various thermal management scenarios can be derived depending on the interior condition of the vehicle, the exterior condition of the vehicle, the states of the vehicle components 110a and 110b, and the like.

FIG. 1 mainly shows components related to the description of the thermal management circuit applicable to embodiments of the present disclosure, and an actual thermal management system may be implemented by including more or fewer components.

Hereafter, the operation performed by a controller that controls the components of the aforementioned thermal management system is described.

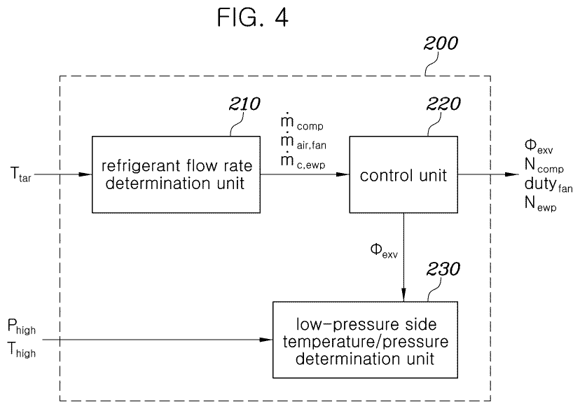

FIG. 4 is a diagram illustrating a controller according to an embodiment of the present disclosure.

Referring to FIG. 4, the controller 200 may control the opening amount φₑₓᵥ of the expansion valves 153a and 153b, the operating amount N_{comp} of the compressor 151, the operating amount duty_{fan} of the cooling fan 171, and the operating amount N_{ewp} of a coolant pump depending on a target temperature Tₜₐᵣ. The controller may include a communication device that communicates with other controllers or sensors for controlling functions of the controller, a memory that stores an operating system or logic instructions and input/output information, and one or more processors that perform determination, calculation, decision, and the like necessary for controlling the functions.

More specifically, a refrigerant flow rate determination unit 210 may determine a flow rate \dot{m}_{comp} Of refrigerant discharged from the compressor 151 (compressor discharge refrigerant flow rate \dot{m}_{comp}) based on the target temperature Tₜₐᵣ and may also determine an air flow rate \dot{m}_{air,fan} through the cooling fan 171 and a coolant flow rate \dot{m}_{c,ewp} through coolant pumps 121, 122, and 123. In this case, the refrigerant flow rate determination unit 210 may separately determine the compressor discharge refrigerant flow rate \dot{m}_{comp} and accordingly, may determine the air flow rate \dot{m}_{air,fan} through the cooling fan 171 and the coolant flow rate \dot{m}_{c,ewp} through the coolant pumps 121, 122, and 123.

For example, the refrigerant flow rate determination unit 210 may determine, as the compressor discharge refrigerant flow rate \dot{m}_{comp}, a refrigerant flow rate that satisfies the target temperature in the heat exchanger and minimizes power consumption of the compressor 151 within a preset prediction range. The prediction range means a time range, and through the above method, an optimal refrigerant flow rate that minimizes power consumption for a certain period of time from the current time can be obtained.

In this case, the air flow rate \dot{m}_{air,fan} through the cooling fan 171 and the coolant flow rate \dot{m}_{c,ewp} through the coolant pumps 121, 122, and 123 may be determined according to the determined compressor discharge refrigerant flow rate \dot{m}_{comp}.

On the other hand, the refrigerant flow rate determination unit 210 may determine, as the compressor discharge refrigerant flow rate \dot{m}_{comp}, a refrigerant flow rate that satisfies the target temperature in the heat exchanger and minimizes the total power consumption of the compressor 151, the cooling fan 171, and the coolant pumps 121, 122, and 123 within the preset prediction range.

The target temperature in the heat exchanger is a target temperature in the water-cooled condenser 154a when heat is exchanged through the expansion valve 153a and the water-cooled condenser 154a as shown in FIG. 2, and may be determined by the temperature of the vehicle component 110a that is a heat management target, the coolant temperature, and the like. In addition, when heat is exchanged through the expansion valve 153b and the chiller 159 as shown in FIG. 3, the target temperature in the heat exchanger is a target temperature in the chiller 159 and may be determined by the temperature of the vehicle component 110b that is a heat management target, the coolant temperature, and the like.

The control unit 220 may control the expansion valves 153a and 153b based on the determined compressor discharge refrigerant flow rate \dot{m}_{comp}, air flow rate \dot{m}_{air,fan}, and coolant flow rate \dot{m}_{c,ewp}, and further control the operations of the compressor 151, the cooling fan 171, and the coolant pumps 121, 122, and 123.

The control unit 220 may output the opening amount φₑₓᵥ of the expansion valves 153a and 153b, the operating amounts of the compressor 151, the cooling fan 171, and the coolant pumps 121, 122, and 123 to respective control targets.

The opening amount φₑₓᵥ of the expansion valves 153a and 153b may mean the degree of opening between the fully open state and the fully closed state of the expansion valves 153a and 153b, may mean the opening amount of the expansion valve 153a in the case of heat exchange through the expansion valve 153a and the water-cooled condenser 154a as in FIG. 2, and may mean the opening amount of the expansion valve 153b in the case of heat exchange through the expansion valve 153b and the chiller 159 as in FIG. 3.

The operating amounts of the compressor 151, the cooling fan 171, and the coolant pumps 121, 122, and 123 may be output in the form of a rotation speed N_{comp} of a motor driving the compressor 151, a driving duty duty_{fan} of a motor driving the cooling fan 171, and a rotation speed N_{ewp} of a motor driving the coolant pumps 121, 122, and 123, respectively.

The control unit 220 controls the opening amount φₑₓᵥ of the expansion valve 153a or 153b based on the compressor discharge refrigerant flow rate \dot{m}_{comp}, and in this case, the temperature and pressure on the side of the heat exchanger such as the water-cooled condenser 154a or the chiller 159 may not be considered when controlling the opening amount φₑₓᵥ of the expansion valve 153a or 153b. In other words, in an embodiment, the control unit 220 may control the opening amount φₑₓᵥ of the expansion valve 153a or 153b only depending on the compressor discharge refrigerant flow rate \dot{m}_{comp} regardless of the temperature and pressure on the heat exchanger side. Accordingly, in an embodiment, the temperature and pressure on the heat exchanger side are not required to control the opening amount φₑₓᵥ of the expansion valve 153a or 153b, and thus a low-pressure side sensor that detects the temperature and pressure on the heat exchanger side can be omitted.

More specifically, the control unit 220 may control the opening amount φₑₓᵥ of the expansion valve 153a or 153b such that the flow rate of the refrigerant passing through the expansion valve 153a or 153b corresponds to the compressor discharge refrigerant flow rate \dot{m}_{comp}, and may control the opening amount φₑₓᵥ of the expansion valve 153a or 153b to a minimum opening amount (i.e., a lowest value of opening) that allows the flow rate of the refrigerant passing through the expansion valve to match the compressor discharge refrigerant flow rate \dot{m}_{comp}. However, cases in which the flow rate of the refrigerant passing through the expansion valve 153a or 153b corresponds to the compressor discharge refrigerant flow rate \dot{m}_{comp} may include a case in which the difference between e flow rate of the refrigerant passing through the expansion valve and the compressor discharge refrigerant flow rate \dot{m}_{comp} is within a preset tolerance range as well as a case in which the flow rate of the refrigerant passing through the expansion valve corresponds to the compressor discharge refrigerant flow rate \dot{m}_{comp}.

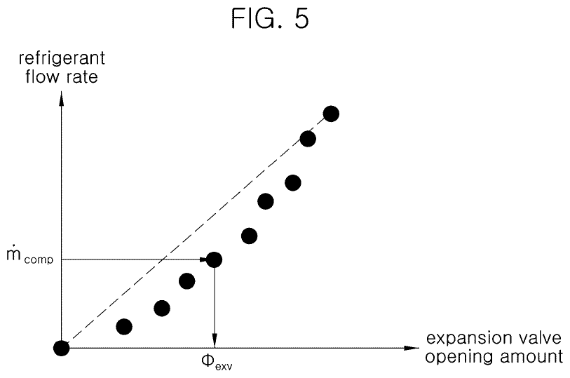

The control unit 220 may refer to a table having the compressor discharge refrigerant flow rate \dot{m}_{comp} as an input value and having the opening amount φₑₓᵥ corresponding thereto as an output value in order to control the opening amount φₑₓᵥ of the expansion valve 153a or 153b based on the compressor discharge refrigerant flow rate \dot{m}_{comp}. This is described below with reference to FIG. 5.

FIG. 5 is a diagram illustrating a method of controlling the opening amount of an expansion valve according to an embodiment of the present disclosure.

FIG. 5 illustrates the relationship between the compressor discharge refrigerant flow rate \dot{m}_{comp} and the opening amount φₑₓᵥ of the expansion valve 153a or 153b applied to the table for controlling the opening amount φₑₓᵥ of the expansion valve 153a or 153b. Each value of the compressor discharge refrigerant flow rate \dot{m}_{comp} is matched with each value of the opening amount φₑₓᵥ of the expansion valve 153a or 153b. In this case, the opening amount φₑₓᵥ Of the expansion valve 153a or 153b corresponding to a specific value of the compressor discharge refrigerant flow rate \dot{m}_{comp} may be set such that the flow rate of the refrigerant passing through the expansion valve 153a or 153b matches the compressor discharge refrigerant flow rate \dot{m}_{comp}. For example, the opening amount φₑₓᵥ of the expansion valve 153a or 153b may be set using the following formula.

$${ϕ}_{exv} = \frac{{\dot{m}}_{comp}}{A \sqrt{{ρ}_{in} ( {P}_{in} - {P}_{out} )}}$$

In this formula, A is the refrigerant inflow area when the expansion valve 153a or 153b is fully opened, ρᵢₙ is the density of the refrigerant flowing into the expansion valve 153a or 153b, and Pᵢₙ and Pₒᵤₜ represent refrigerant pressures at the inlet and outlet sides, respectively, of the expansion valve 153a or 153b.

According to such opening amount control, the refrigerant discharged from the compressor 151 can pass through the expansion valve 153a or 153b without a change in flow rate thereof, and it is possible to prevent energy consumption, generation of high pressure, and the like that occur when the flow rate of the refrigerant passing through the expansion valve 153a or 153b does not match the flow rate of the refrigerant discharged from the compressor 151.

Referring back to FIG. 4, the controller 200 may further include a low-pressure side temperature/pressure determination unit 230. The low-pressure side temperature/pressure determination unit 230 may determine at least one of the pressure or temperature of the refrigerant on the side of the outlet of the expansion valve 153a or 153b based on the opening amount φₑₓᵥ of the expansion valve 153a or 153b. In other words, in an embodiment, it is possible to obtain the temperature and pressure of the refrigerant on the low pressure side using the low-pressure side temperature/pressure determination unit 230 instead of using a low-pressure side sensor.

More specifically, the low-pressure side temperature/pressure determination unit 230 may determine refrigerant pressure variation at the expansion valve 153a or 153b based on the opening amount φₑₓᵥ of the expansion valve 153a or 153b, and may determine the pressure of the refrigerant on the outlet side of the expansion valve 153a or 153b based on the determined refrigerant pressure variation and the pressure P_{high} of the refrigerant on the outlet side of the compressor 151 detected by the high-pressure side sensor S, i.e., pressure on the high pressure side. For example, the low-pressure side temperature/pressure determination unit 230 may determine the pressure of the refrigerant on the outlet side of the expansion valve 153a or 153b using the following formula.

$${P}_{out , exv} = {P}_{in , exv} + Δ {P}_{exv}$$

In this formula, P_{out,exv} is the pressure of the refrigerant on the outlet side of the expansion valve 153a or 153b, and P_{in,exv} is the pressure of the refrigerant on the inlet side of the expansion valve 153a or 153b, and the pressure P_{high} on the outlet side of the compressor 151 obtained through the high-pressure side sensor S may be used as P_{in,exv}. ΔPₑₓᵥ represents refrigerant pressure variation at the expansion valve 153a or 153b, and is a value determined according to the opening amount φₑₓᵥ of the expansion valve 153a or 153b. For example, the refrigerant pressure variation may be obtained by referring to a table in which values of refrigerant pressure variation according to the opening amount φₑₓᵥ of the expansion valve 153a or 153b are previously stored.

Furthermore, the low-pressure side temperature/pressure determination unit 230 may determine the temperature of the refrigerant on the outlet side of the expansion valve 153a or 153b based on the pressure P_{high} and temperature T_{high} of the refrigerant on the outlet side of the compressor 151 detected by the high-pressure side sensor S, and the determined refrigerant pressure on the outlet side of the expansion valve 153a or 153b. For example, the low-pressure side temperature/pressure determination unit 230 may determine the temperature of the refrigerant on the outlet side of the expansion valve 153a or 153b using the following formula.

$${T}_{s} = {{T}_{d} [ 1 + \frac{{( \frac{{p}_{in , exv}}{{P}_{out , exv}} )}^{\frac{γ - 1}{γ}} - 1}{{η}_{isen}} ]}^{- 1}$$

In this formula, Tₛ represents the temperature on the outlet side of the expansion valve 153a or 153b, and T_{d} represents the temperature on the outlet side of the compressor 151. ηᵢₛₑₙ is the isentropic process efficiency of the compressor 151, which can be obtained through a map of the operating amount of the compressor 151 and the refrigerant pressure. γ is a constant, and the ratio of isobaric specific heat to isochoric specific heat may be used in an isentropic process, and a setting value such as 1.088 may be used in a multidirectional process.

In addition, the pressure and temperature on the outlet side of the expansion valve 153a or 153b may mean the pressure and temperature on the outlet side of the expansion valve 153a when heat is exchanged through the expansion valve 153a and the water-cooled condenser 154a as in FIG. 2, and may mean the pressure and temperature on the outlet side of the expansion valve 153b when heat is exchanged through the expansion valve 153b and the chiller 159 as in FIG. 3.

Since the low-pressure side temperature/pressure determination unit 230 determines the temperature and pressure on the outlet side of the expansion valve 153a or 153b in this manner, a separate sensor can be omitted on the low-pressure side, thereby simplifying the configuration of the refrigerant line RL and reducing the cost of installing the sensor.

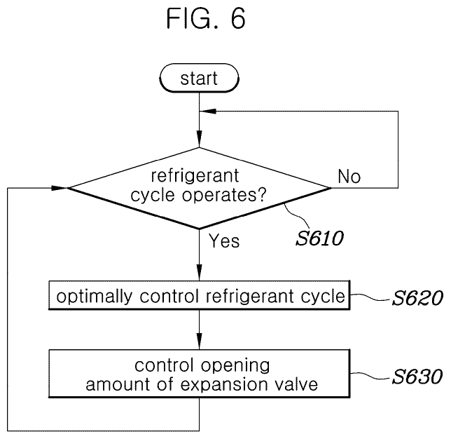

Hereinafter, a process of controlling a thermal management system according to an embodiment of the present disclosure is described with reference to FIG. 6.

FIG. 6 is a diagram illustrating a method of controlling the thermal management system according to an embodiment of the present disclosure.

Referring to FIG. 6, the controller 200 determines whether a refrigerant cycle in which refrigerant circulates through the compressor 151, the condenser 152, the expansion valves 153a and 153b, and the heat exchanger through the refrigerant line RL is in operation (S610).

If the refrigerant cycle is not in operation (No in S610), there is no need to adjust the opening amount φₑₓᵥ of the expansion valves 153a and 153b, and thus subsequent control may not be performed. If the refrigerant cycle is in operation (Yes in S610), the compressor discharge refrigerant flow rate \dot{m}_{comp} is determined through optimal control of the refrigerant cycle (S620).

Thereafter, the controller 200 controls the opening amount φₑₓᵥ of the expansion valves 153a and 153b based on the determined compressor discharge refrigerant flow rate \dot{m}_{comp} (S630), and in this case, the opening amount φₑₓᵥ of the expansion valves 153a and 153b may be controlled such that the flow rate of the refrigerant passing through the expansion valves corresponds to the compressor discharge refrigerant flow rate \dot{m}_{comp}.

According to various embodiments of the present disclosure as described above, the flow rate of refrigerant passing through the expansion valve is controlled through an opening amount corresponding to the flow rate of the refrigerant output from the compressor such that the refrigerant output from the compressor can pass through the expansion valve without a change in flow rate thereof, thereby preventing occurrence of abnormal pressure or deterioration of the performance of the heat exchanger.

The effects that can be obtained from the present disclosure are not limited to the effects mentioned above, and other effects that are not mentioned should be clearly understood by those having ordinary skill in the art to which the present disclosure belongs from the description below.

Although the present disclosure has been illustrated and described with respect to specific embodiments as described above, it should be apparent to those having ordinary skill in the art that the present disclosure can be modified and changed in various manners without departing from the technical idea of the present disclosure provided by the following claims.

What is claimed is:

1. A thermal management system comprising:
a refrigerant line configured to circulate a refrigerant, wherein the refrigerant is configured to pass through a compressor, a condenser, an expansion valve, and a heat exchanger; and
a controller configured to:
determine a flow rate of the refrigerant discharged from the compressor based on a target temperature in the heat exchanger; and
control an opening amount of the expansion valve based on the determined flow rate of the refrigerant.

2. The thermal management system of claim 1, wherein the controller is further configured to control the opening amount of the expansion valve based on the flow rate of the refrigerant and not based on a temperature and a pressure on a side of the heat exchanger.

3. The thermal management system of claim 1, wherein the controller is further configured to control the opening amount of the expansion valve such that a flow rate of the refrigerant passing through the expansion valve corresponds to the determined flow rate of the refrigerant.

4. The thermal management system of claim 3, wherein the controller is further configured to control the opening amount of the expansion valve to a minimum opening amount that allows the flow rate of the refrigerant passing through the expansion valve to match the flow rate of the refrigerant discharged from the compressor.

5. The thermal management system of claim 3, wherein the controller is further configured to control the opening amount of the expansion valve by referring to a table having the flow rate of the refrigerant as an input value and having an opening amount of the expansion valve corresponding to the input value as an output value.

6. The thermal management system of claim 1, wherein the controller is further configured to determine a pressure of the refrigerant on a side of an outlet of the expansion valve based on the opening amount of the expansion valve.

7. The thermal management system of claim 6, further comprising a high-pressure side sensor provided on a side of an outlet of the compressor, configured to detect a pressure of the refrigerant on the side of the outlet of the compressor,
wherein the controller is further configured to determine a refrigerant pressure variation at the expansion valve based on the opening amount of the expansion valve, and determine the pressure of the refrigerant on the side of the outlet of the expansion valve based on the determined refrigerant pressure variation and the pressure of the refrigerant on the side of the outlet of the compressor detected by the high-pressure side sensor.

8. The thermal management system of claim 7, wherein the high-pressure side sensor further detects a temperature of the refrigerant on the side of the outlet of the compressor, and the controller determines a temperature of the refrigerant on the side of the outlet of the expansion valve based on the pressure and the temperature of the refrigerant on the side of the outlet of the compressor detected by the high-pressure side sensor, and the determined pressure of the refrigerant on the side of the outlet of the expansion valve.

9. The thermal management system of claim 1, wherein the controller is further configured to determine the flow rate of the refrigerant based on a refrigerant flow rate that satisfies the target temperature in the heat exchanger and minimizes power consumption of the compressor within a preset prediction range.

10. The thermal management system of claim 9, further comprising:
at least one coolant line having a coolant pump for circulating a coolant exchanging heat with the refrigerant through the heat exchanger; and
a cooling fan for introducing air into a heat management target exchanging heat with the coolant,
wherein the controller is further configured to determine the flow rate of the refrigerant based on a refrigerant flow rate that satisfies the target temperature in the heat exchanger and minimizes total power consumption of the compressor, the coolant pump, and the cooling fan within the preset prediction range.

11. A method of controlling a thermal management system, the method comprising:
determining a flow rate of a refrigerant discharged from a compressor based on a target temperature in a heat exchanger; and
controlling an opening amount of an expansion valve based on the determined flow rate of the refrigerant.

12. The method of claim 11, wherein the controlling includes controlling the opening amount of the expansion valve based on the flow rate of the refrigerant and not based on a temperature and a pressure on a side of the heat exchanger.

13. The method of claim 11, wherein the controlling includes controlling the opening amount of the expansion valve such that a flow rate of the refrigerant passing through the expansion valve corresponds to the determined flow rate of the refrigerant.

14. The method of claim 13, wherein the controlling includes controlling the opening amount of the expansion valve to a minimum opening amount that allows the flow rate of the refrigerant passing through the expansion valve to match the flow rate of the refrigerant discharged from the compressor.

15. The method of claim 13, wherein the controlling includes controlling the opening amount of the expansion valve by referring to a table having the flow rate of the refrigerant discharged from the compressor as an input value and having an opening amount of the expansion valve corresponding to the input value as an output value.

16. The method of claim 11, further comprising determining a pressure of the refrigerant on a side of an outlet of the expansion valve based on the opening amount of the expansion valve.

17. The method of claim 16, wherein the determining the pressure includes determining a refrigerant pressure variation at the expansion valve based on the opening amount of the expansion valve, and determining the pressure of the refrigerant on the side of the outlet of the expansion valve based on the determined refrigerant pressure variation and a pressure of the refrigerant on a side of an outlet of the compressor detected by a high-pressure side sensor provided on the side of the outlet of the compressor.

18. The method of claim 17, further comprising determining a temperature of the refrigerant on the side of the outlet of the expansion valve based on the pressure, and a temperature of the refrigerant on the side of the outlet of the compressor detected by the high-pressure side sensor, and the determined pressure of the refrigerant on the side of the outlet of the expansion valve.

19. The method of claim 11, wherein the determining includes determining the flow rate of the refrigerant discharged from the compressor based on a refrigerant flow rate that satisfies the target temperature in the heat exchanger and minimizes power consumption of the compressor within a preset prediction range.

20. The method of claim 19, wherein the determining includes determining the flow rate of the refrigerant discharged from the compressor based on a refrigerant flow rate that satisfies the target temperature in the heat exchanger and minimizes total power consumption of the compressor, a coolant pump provided on a coolant line circulating a coolant exchanging heat with the refrigerant through the heat exchanger, and a cooling fan for introducing air into a heat management target exchanging heat with the coolant within the preset prediction range.
